(19) United States
(12) Patent Application Publication
(10) Pub. No.: US 2025/0044190 A1
(43) Pub. Date: Feb. 6, 2025

(54) METHOD FOR CHARACTERIZING AT LEAST PART OF A LENS ELEMENT

(71) Applicant: ESSILOR INTERNATIONAL, CHARENTON-LE-PONT (FR)

(72) Inventors: Matthieu GUILLOT, ISSY LES MOULINEAUX (FR); Eric GACOIN, PARIS (FR); Bruno FERMIGIER, MAISONS ALFORT (FR); Patrick HUGONNEAUX, Champigny-sur-Marne (FR)

(21) Appl. No.: 18/836,095

(22) PCT Filed: Mar. 27, 2023
(86) PCT No.: PCT/EP2023/057761

§ 371 Date: Aug. 6, 2024

(30) Foreign Application Priority Data
Mar. 27, 2022 (EP) 22305379.4

(51) Int. Cl. G01M 11/02; G02C 7/02; G02C 7/06

(52) U.S. Cl. CPC G01M 11/0228; G02C 7/022; G02C 7/027; G02C 7/06; G02C 2202/24

(57) ABSTRACT

Method, for example implemented by computer means, for characterizing at least part of a lens element adapted for a wearer and comprising a plurality of optical elements, each optical element of the plurality of optical elements providing at least an optical power, for example so as to at least one of slow down, retard or prevent a progress of the abnormal refraction of the eye of the wearer; wherein the method comprises: —obtaining a two-dimension representation of the local optical power of at least part of the lens element using a deflectometry method, for example a fringe deflectometry method, —determining the optical power distribution over at least part of the two-dimension representation of the lens element, and—characterizing at least the part of the lens element within said at least part of the two-dimension representation of the lens element by analyzing the determined optical power distribution.

### TECHNICAL FIELD

The disclosure relates to a method, for example implemented by computer means, for characterizing at least part of a lens element adapted for a wearer and comprising a plurality of optical elements, each optical element of the plurality of optical elements providing at least an optical power, for example so as to at least one of slow down, retard or prevent a progress of the abnormal refraction of the eye of the wearer.

The disclosure further relates to a method, for example implemented by computer means, for checking the conformity of a manufactured lens element adapted for a wearer and comprising a plurality of optical elements, each optical element of the plurality of optical elements providing at least an optical power so as to at least one of slow down, retard or prevent a progress of the abnormal refraction of the eye of the wearer.

The disclosure also relates to a method, for example implemented by computer means, for controlling a lens element manufacturing process for manufacturing lens elements, each lens element being adapted for a wearer and comprising a plurality of optical elements, each optical element of the plurality of optical elements providing at least an optical power so as to at least one of slow down, retard or prevent a progress of the abnormal refraction of the eye of the wearer

### BACKGROUND OF THE DISCLOSURE

Myopia of an eye is characterized by the fact that the eye focuses distant objects in front of its retina. Myopia is usually corrected using a concave lens and hypermetropia is usually corrected using a convex lens.

It has been observed that some individuals when corrected using conventional single vision optical lenses, in particular children, focus inaccurately when they observe an object which is situated at a short distance away, that is to say, in near vision conditions. Because of this focusing defect on the part of a myopic child which is corrected for his far vision, the image of an object close by is also formed behind his retina, even in the foveal area.

Such focusing defect may have an impact on the progression of myopia of such individuals. One may observe that for most of said individuals the myopia defect tends to increase over time.

Recent controlled clinical trials provided evidence of the benefit of optical elements, such as microlenses, in the peripheral visual field to slow down myopia progression. The purpose of the optical elements is to provide an optical blurred image, in front of the retina of the wearer, triggering a stop signal to the eyes growth.

The central area of the lens element having the optical elements may be free of optical elements, to enable a good vision.

Recent studies also showed that myopia progression could be slowed down by providing a slight diffusion in the periphery visual field, with arrays of small dots. The basic principle of this solution is to decrease the contrast of the eye elongation signal, in the peripheral visual field.

In the areas of the lens element comprising optical elements (like microlenses, or dots of diffusion, or concentric rings of defocus) we can find alternance of two main areas: the “refractive areas” used to correct the myopia of the wearer, and the “defocus areas” used to control the myopia.

New optical designs propose arrays of contiguous microlenses covering the lens element, without large “refractive areas” free of optical elements: that means that each optical element creates both functions of myopia Rx correction (or create a blur acceptable for the good vision of the wearer) and myopia control defocus signal.

Different designs of contiguous optical elements have been designed with refractive designs (unifocal spherical or aspherical, bifocal microlenses) or diffractive designs (Pi-Fresnel microlenses).

As disclosed in WO2021/069443 characterizing optical elements one a lens element is challenging.

The new design of optical elements, such as contiguous and small diameters, or small areas inside optical elements, make the characterization even more complex.

The method disclosed in WO2021/069443 does not appear to be very efficient on some of the new designs of optical elements, especially on diffractive designs such as Pi-Fresnel optical elements which have inside each optical elements very small rings and discontinuities. Due to the dimensions of zones inside the optical elements, and due to the diffractive behavior of the optical elements the characterization is made more complex.

Therefore, it appears that there is a need for a new method of characterizing at least part of a lens element adapted for a wearer and comprising a plurality of optical elements, each optical element of the plurality of optical elements providing at least an optical power, for example so as to at least one of slow down, retard or prevent a progress of the abnormal refraction of the eye of the wearer. The method should not present the drawbacks of the existing methods.

### SUMMARY OF THE DISCLOSURE

To this end, the disclosure proposes a method, for example implemented by computer means, for characterizing at least part of a lens element adapted for a wearer and comprising a plurality of optical elements, each optical element of the plurality of optical elements providing at least an optical power, for example so as to at least one of slow down, retard or prevent a progress of the abnormal refraction of the eye of the wearer;
wherein the method comprises:
   obtaining a two-dimension representation of the local optical power of at least part of the lens element using a deflectometry method, for example a fringe deflectometry method,
   determining the optical power distribution over at least part of the two-dimension representation of the lens element, and
   characterizing at least the part of the lens element within said at least part of the two-dimension representation of the lens element by analyzing the determined optical power distribution.

Advantageously, determining the optical power distribution over at least part of the two-dimension representation of the lens element and analyzing such optical power distribution has been found to allow an accurate characterization of the at least part of the lens element and in particular of at least part of the optical elements of the lens element.

The method of the disclosure allows characterizing the lens element using existing deflectometry measuring devices. Such measurements can be carried out very quickly.

Alternatively, other deflectometry methods may be used, for example using light wave analyzer that projects a beam of light rays through the lens element and deducing from the measurement of the deviation of the light rays the local curvature of the lens element.

Unlike the characterization method disclosed in WO2021/069443 for which local power measurements are used, the method of the disclosure is based on the distribution of local curvature and extracting statistical number (peak(s) position(s), peak(s) width(s)) to characterize the lens element and in particular the optical elements (powers, asphericity parameters, or global defect of the lens).

The method of the disclosure is particularly beneficial for simultaneous multipower design, since even if the lens element creates multiple wavefronts (for instance a wave front for order 0 and a second wavefront for order 1 for Pi-Fresnel), the method of the disclosure may be used for characterization.

According to further embodiments which can be considered alone or in combination:
the lens element comprises a refraction area configured to provide to the wearer in standard wearing conditions, in particular for foveal vision, a first optical power based on the prescription of the wearer, the optical elements providing at least a second optical power; and/or
the refraction area is formed as the area other than the areas formed of the plurality of optical elements; and/or
the lens element comprises a refraction area configured to provide to the wearer in standard wearing conditions, in particular for foveal vision, a first optical power, the optical elements providing at least a second optical power, the first optical power and the at least second optical power being based on the prescription of the wearer; and/or
the lens element comprises a refraction area configured to provide to the wearer in standard wearing conditions, in particular for foveal vision, a first optical power, the optical elements providing at least a second optical power, the sum of the first optical power and the at least second optical power being based on the prescription of the wearer; and/or
the two-dimension representation of the local optical power is obtained using a pupil diameter greater than or equal to 4 mm and smaller than or equal to 15 mm; and/or
the two-dimension representation of the local optical power corresponds to at least 25%, for example at least 50%, for example at least 80%, of the surface of the lens element; and/or
the two-dimension representation of the local optical power corresponds to at least a part of the lens element that comprises at least 25%, for example at least 40%, for example at least 80%, of the optical elements; and/or
the images used for the deflectometry method consist of pixels smaller than or equal to 0.05 mm×0.05 mm; and/or
the part of the lens element within said at least part of the two-dimension representation of the lens element is characterized based on at least the optical power value of at least one peak of the determined optical power distribution, and/or
the part of the lens element within said at least part of the two-dimension representation of the lens element is characterized based on at least the surface of at least one peak of the determined optical power distribution, and/or
the part of the lens element within said at least part of the two-dimension representation of the lens element is characterized based on at least the width value of at least one peak of the determined optical power distribution, and/or
the part of the lens element within said at least part of the two-dimension representation of the lens element is characterized based on at least the degree of symmetry of at least one peak of the determined optical power distribution; and/or
the method characterizes at least part of the optical elements within said at least part of the two-dimension representation of the lens element; and/or
at least 50%, for example 90%, for example all, of the optical elements are multifocal lenslets; and/or
at least 50%, for example 90%, for example all, of the optical elements are diffractive lenslets; and/or
the diffractive lenses are contiguous diffractive lenslets; and/or
the method comprises:
   obtaining at least two two-dimension representation of the local optical power of at least part of the lens element using a deflectometry method at at least two different wavelengths,
   determining the optical power distribution over at least part of each of the at least two two-dimension representation of the lens element, and
   characterizing the optical elements by comparing the at least two determined optical power distribution; and/or
one of the at least two different wavelengths correspond to the nominal wavelength of the diffractive lenslets; and/or
at least 50%, for example at least 90%, for example all, of the optical elements are refractive lenslets; and/or
at least 50%, for example at least 90%, for example all, of the optical elements are diffusive lenslets; and/or
the lens element comprises a refraction area having a refractive power based on the prescription for correcting an abnormal refraction of an eye of the wearer; and/or
at least part, for example all, of the front and/or the back surface of the lens element is covered with a coating; and/or
at least part, for example all, of the optical elements are located on the front surface of the lens element; and/or
at least part, for example all, of the optical elements are located on the back surface of the lens element; and/or
at least part, for example all, of the optical elements are located between the front and the back surfaces of the lens element; and/or
characterizing at least part of the plurality of optical elements comprises at least identifying the center of at least part of the optical elements, for example using a Hough transform algorithm; and/or
characterizing at least part of the plurality of optical elements comprises at least determining the optical power at the center of at least part of the optical elements; and/or
characterizing at least part of the plurality of optical elements comprises at least determining the global optical power of at least part of the optical elements; and/or
characterizing at least part of the plurality of optical elements comprises at least determining the optical cylinder value and the optical cylinder axis of at least part of the optical elements; and/or
characterizing at least part of the plurality of optical elements comprises at least determining the peripheral optical power of at least part of the optical elements; and/or
characterizing at least part of the plurality of optical elements comprises at least determining the asphericity of at least part of the optical elements; and/or
characterizing at least part of the plurality of optical elements comprises at least determining the number of optical elements; and/or
characterizing at least part of the plurality of optical elements comprises at least determining the density of optical elements; and/or
characterizing at least part of the plurality of optical elements comprises determining the ratio of the surface of the lens element having an optical power greater than or equal to a first threshold value and smaller than or equal to a second threshold value; and/or
characterizing at least part of the plurality of optical elements comprises at least determining the positions of the optical elements; and/or
characterizing at least part of the plurality of optical elements comprises at least determining the size of at least part of the optical elements; and/or characterizing at least part of the plurality of optical elements comprises determining the optical power of the refraction around, for example in the vicinity of, the optical element and subtracting said optical power to the two-dimension representation of the local optical power; and/or
the optical elements have a contour shape being inscribable in a circle having a diameter greater than or equal to 0.1 mm and smaller than or equal to 7.0 mm, for example smaller than or equal to 3.0 mm; and/or
the optical elements are positioned on a mesh; and/or
the mesh is a structured mesh; and/or
the optical elements are positioned along a plurality of concentric rings; and/or
the lens element further comprises at least four optical elements organized in at least two groups of contiguous optical elements; and/or
each group of contiguous optical element is organized in at least two concentric rings having the same center, the concentric ring of each group of contiguous optical element being defined by an inner diameter corresponding to the smallest circle that is tangent to at least one optical element of said group and an outer diameter corresponding to the largest circle that is tangent to at least one optical elements of said group; and/or
at least part of, for example all the concentric rings of optical elements are centered on the optical center of the surface of the lens element on which said optical elements are disposed; and/or
the concentric rings of optical elements have a diameter comprised between 9.0 mm and 60 mm; and/or
the distance between two successive concentric rings of optical elements is greater than or equal to 0.5 mm, the distance between two successive concentric rings being defined by the difference between the outer diameter of a first concentric ring and the inner diameter of a second concentric ring, the second concentric ring being closer to the periphery of the lens element; and/or
the optical element further comprises optical elements positioned radially between two concentric rings; and/or
the structured mesh is a squared mesh or a hexagonal mesh or a triangle mesh or an octagonal mesh; and/or
the mesh structure is a random mesh, for example a Voronoid mesh; and/or
at least part, for example all, of the optical elements have a constant optical power and a discontinuous first derivative between two contiguous optical elements; and/or
at least part, for example all, of the optical elements have a varying optical power and a continuous first derivative between two contiguous optical elements; and/or
at least one, for example all, of the optical element has an optical function of focusing an image on a position other than the retina in standard wearing conditions; and/or
at least one optical element has a non-spherical focused optical function in standard wearing conditions and for peripheral vision; and/or
at least one of the optical elements has a cylindrical power; and/or
the optical elements are configured so that along at least one, section of the lens element, for example a section passing by the optical center of the lens element, the mean sphere of optical elements increases from a point of said section towards the peripheral part of said section; and/or
the optical elements are configured so that along at least one section of the lens the cylinder of optical elements increases from a point of said section towards the peripheral part of said section; and/or
the optical elements are configured so that along the at least one section of the lens the mean sphere and/or the cylinder of optical elements increases from the center of said section towards the peripheral part of said section; and/or
the refraction area comprises an optical center and the optical elements are configured so that along at least one, for example at least 50%, for example any, section passing through the optical center of the lens the mean sphere and/or the cylinder of the optical elements increases from the optical center towards the peripheral part of the lens; and/or
the refraction area comprises a far vision reference point, a near vision reference, and a meridian joining the far and near vision reference points, the optical elements are configured so that in standard wearing conditions along any horizontal section of the lens the mean sphere and/or the cylinder of the optical elements increases from the intersection of said horizontal section with the meridian towards the peripheral part of the lens; and/or
the mean sphere and/or the cylinder increase functions along the sections are different depending on the position of said section along the meridian; and/or
the mean sphere and/or the cylinder increase functions along the sections are unsymmetrical; and/or
the optical elements are configured so that in standard wearing conditions the at least one section is a horizontal section; and/or
the mean sphere and/or the cylinder of optical elements increases from a first point of said section towards the peripheral part of said section and decreases from a second point of said section towards the peripheral part of said section, the second point being closer to the peripheral part of said section than the first point; and/or
the mean sphere and/or the cylinder increase function along the at least one section is a Gaussian function; and/or
the mean sphere and/or the cylinder increase function along the at least one section is a Quadratic function; and/or
the optical elements are configured so that the mean focus of the light rays passing through each optical element is at a same distance to the retina; and/or
the refractive area is formed as the area other than the areas formed as the plurality of optical elements; and/or
for every circular zone having a radius comprised between 2 and 4 mm comprising a geometrical center located at a distance of the framing reference that faces the pupil of the user gazing straight ahead in standard wearing conditions greater or equal to said radius +5 mm, the ratio between the sum of areas of the parts of optical elements located inside said circular zone and the area of said circular zone is comprised between 20% and 70%; and/or
at least part, for example all, of the optical elements are located on the front surface of the lens element; and/or
the at least one multifocal refraction lenslet comprises a cylindrical power; and/or
the at least one, for example all, multifocal refractive lenslet comprises an aspherical surface, with or without any rotational symmetry; and/or at least one, for example all, of the optical elements is a toric refractive lenslet; and/or
at least one multifocal refractive lenslet comprises a toric surface; and/or
at least part, for example all, optical functions comprise high order optical aberrations.

The disclosure further relates to a method, for example implemented by computer means, for checking the conformity of a manufactured lens element adapted for a wearer and comprising a plurality of optical elements, each optical element of the plurality of optical elements providing at least an optical power so as to at least one of slow down, retard or prevent a progress of the abnormal refraction of the eye of the wearer,
wherein the method comprises:
   obtaining characterizing data relating to at least one optical characteristic of the optical elements of the lens element to be manufactured,
   characterizing the optical elements of the manufactured lens element using the method according to the disclosure,
   comparing the characteristics of the optical elements of the manufactured lens element with the characterizing data so as to check the conformity of the manufactured lens element.

The disclosure also relates to a method, for example implemented by computer means, for controlling a lens element manufacturing process for manufacturing lens elements, each lens element being adapted for a wearer and comprising a plurality of optical elements, each optical element of the plurality of optical elements providing at least an optical power so as to at least one of slow down, retard or prevent a progress of the abnormal refraction of the eye of the wearer, wherein the method comprises the steps of:
a) manufacturing a lens element according to a manufacturing process,
b) determining at least one characteristic of the manufactured lens element of step a) according to the method of the disclosure,
c) recording the difference between the determined at least one characteristic and a reference value,
d) repeating regularly step a) to c) and checking the evolution of the difference over time,
   wherein the evolution of at least one parameter of the manufacturing process used for manufacturing the lens elements is checked over time and the evolution over time of said difference is related with the evolution over time of the at least one parameter of the manufacturing process.

The disclosure further relates to a computer program product comprising one or more stored sequences of instructions that are accessible to a processor and which, when executed by the processor, causes the processor to carry out the steps of the any method of the disclosure.

The disclosure also relates to a program which makes a computer execute the method of the disclosure.

The disclosure further relates to a computer-readable storage medium having a program recorded thereon, wherein the program makes the computer execute a method according to the disclosure.

The disclosure also relates to a device comprising a processor adapted to store one or more sequence of instructions and to carry out the steps of the method according to the disclosure.

The disclosure also relates to a computer readable medium carrying one or more sequences of instructions of the computer program product according to the disclosure.

### BRIEF DESCRIPTION OF THE DRAWINGS

Non-limiting embodiments of the disclosure will now be described with reference to the accompanying drawing wherein:

FIG. 1 is a plan view of a lens element that may be characterized by a method according to the disclosure;

FIG. 2 is a general profile view of a lens element that may be characterized by a method according to the disclosure;

FIG. 3 is a schematic representation of a fringe deflectometry device;

FIG. 4 illustrates the correlation between the result of the deflectometry measurements and surface measurements;

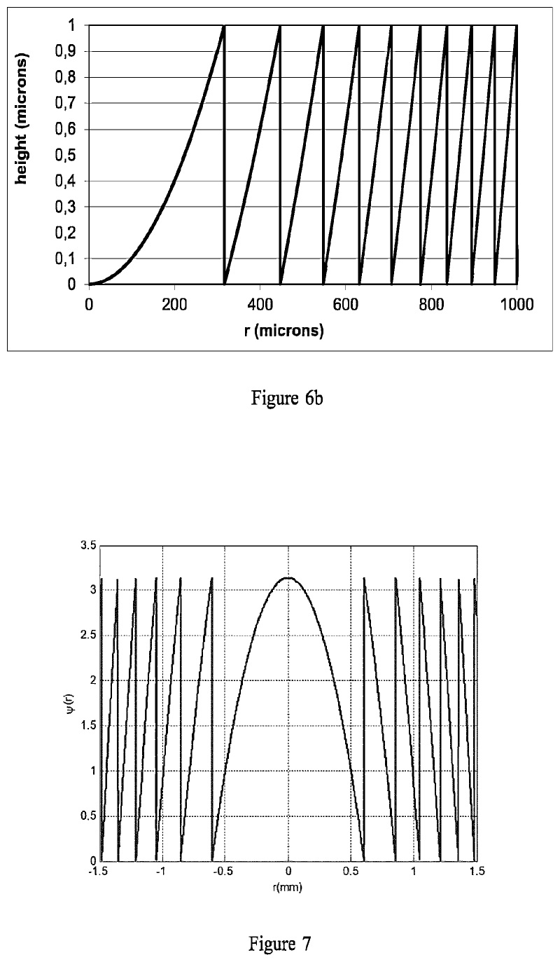

FIG. 5 is an example of two-dimension representation of a lens element according to the disclosure;

FIGS. 6a and 6b represent examples of a diffractive lenslets radial profile;

FIG. 7 illustrates a π-Fresnel lens radial profile;

FIGS. 8a and 8b illustrates diffraction efficiencies of a π-Fresnel lens profile as a function of the wavelength; and

FIGS. 9 to 16 are distribution curves obtained using the method of the disclosure for different lens elements with different types of optical elements.

Elements in the figures are illustrated for simplicity and clarity and have not necessarily been drawn to scale. For example, the dimensions of some of the elements in the figure may be exaggerated relative to other elements to help to improve the understanding of the embodiments of the present disclosure.

### DETAILED DESCRIPTION OF EMBODIMENTS OF THE DISCLOSURE

The disclosure relates to a lens element intended to be worn in front of an eye of a wearer.

In the reminder of the description, terms like «up», «bottom», «horizontal», «vertical», «above», «below», «front», «rear» or other words indicating relative position may be used. These terms are to be understood in the wearing conditions of the lens element.

In the context of the present disclosure, the term “lens element” can refer to an uncut optical lens or a spectacle optical lens edged to fit a specific spectacle frame or an ophthalmic lens and an optical device adapted to be positioned on the ophthalmic lens. The “lens element” in the context of the present disclosure may have a coating such as a hardcoat.

The “lens element” may also refer to a transparent lens mold used to obtain an optical lens, the transparent lens mold having optical elements.

The disclosure relates at least to a method, implemented by computer means for characterizing at least part of the lens element 10.

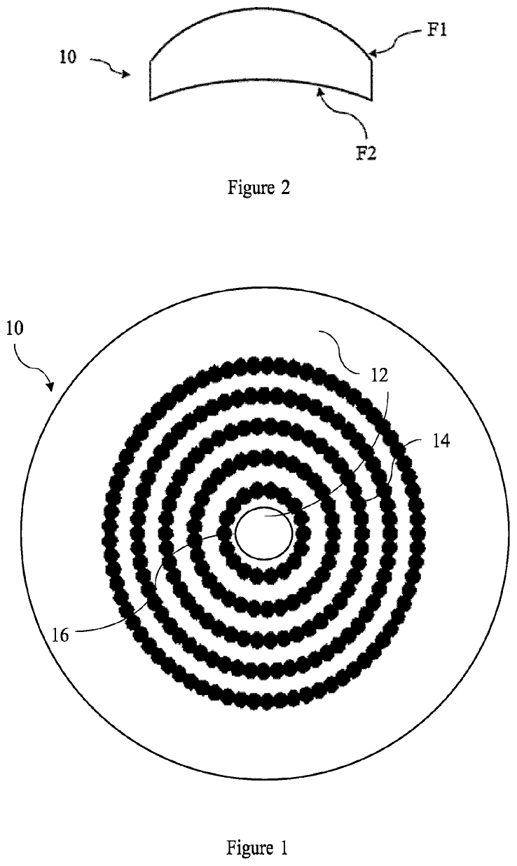

As represented on FIG. 1, a lens element 10 that may be characterized by the method of the disclosure may comprises:
a refraction area 12 having a refractive power based on the prescription for correcting an abnormal refraction of an eye of the wearer, and
a plurality of optical elements 14 providing at least an optical power, for example so as to at least one of slow down, retard or prevent a progress of the abnormal refraction of the eye of the wearer.

The method according to the disclosure comprises obtaining a two-dimension representation of the local optical power of at least part of the lens element using deflectometry method. The method of the disclosure may use a fringe deflectometry method.

In the present disclosure, the method of the disclosure is described using a transmission fringe reflectometry. However, one of ordinary skill could easily adapt the present disclosure using other deflectometry methods, such as for example, reflection deflectometry methods.

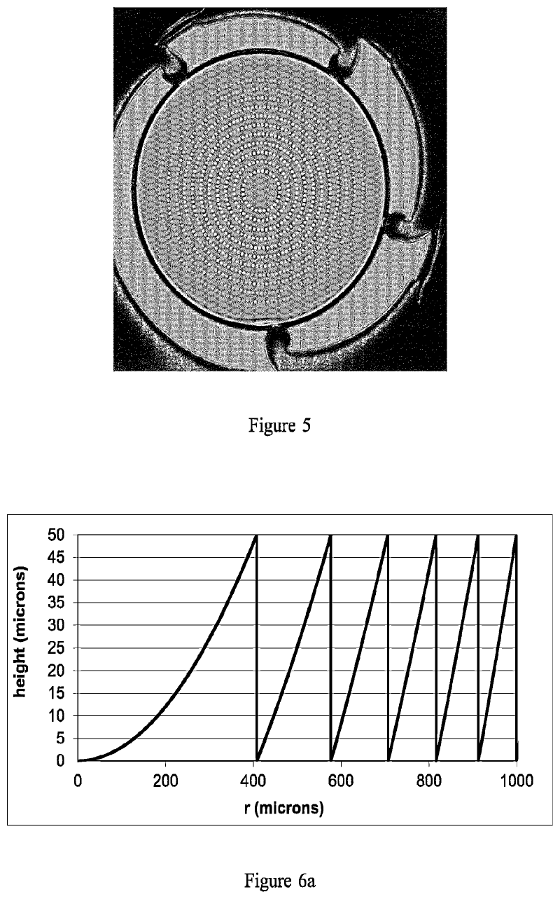

As illustrated on FIG. 3, a fringe deflectometry method consists in positioning a lens element 10 to be characterized between an image display device 20 such as a screen and an image acquisition device 22 such as a camera. On the screen, black and white fringes are scrolled. Their scrolling is observed via the camera with a delay or acceleration which is related to the deviation of the light rays caused locally by the lens element 10.

According to an embodiment of the method of the disclosure, the distance between the screen and the lens element 10 may be of 150 mm and the distance between the screen and the image acquisition device 22 may be of 475 mm.

The deviation of the light rays is the object of an algorithm that allows putting together a mapping of the lens element with color levels or grey levels proportional to the local optical power.

So as to characterize the lens element, the inventor had to adapt the prior art images used in traditional fringe deflectometry methods.

The inventors have determined that to increase the accuracy of the characterization the image used for the deflectometry should consist of pixels smaller than or equal to 0.05 mm×0.05 mm.

In the sense of the disclosure, the feature “image used” corresponds to the result of the transformation of the images acquired by the image acquisition device 22 by using the algorithm. In other words, the calculation is configured to generate an image calibrated to have one pixel covering 0.05×0.05 mm.

The two-dimension representation of the local optical power is obtained by comparing the two-dimension phase shift representation obtained by the deflectometry method with two-dimension reference phase shift representations obtained by said deflectometry method on previously measured reference optical lenses.

In other words, the two-dimension representation of the local optical power may be obtained based on a previous calibration performed with reference optical lenses measured using another device for example a lensmeter or focimeter. This calibration is preferably carried out in back vertex power, and the cylinder is not taken into account during calibration.

As explained in WO2021/069443, there is a very strong correlation between the gray levels of the phase derivative images obtained by a deflectometry method and the optical power values obtained by the surface measurements when such surface measurements are possible.

Therefore, it is clear that a deflectometry method allows obtaining an accurate two-dimension representation of the local power of at least part of the lens element.

Advantageously, a deflectometry method, for example the fringe deflectrometry method, is much easier, cheaper and shorter to implement than the surface measurement.

Furthermore, the method of the disclosure allows characterizing at least part of a lens element, in particular at least part of the optical elements of the optical lens, even when said optical elements are not on one of the front or rear surface of the lens element, for example between the front and rear surface and/or are diffractive optical elements.

As illustrated on FIG. 3, the lens element 10 may be positioned on a support, with its convex face towards the screen 20. On the screen a diffuser that reduces the noise on the final result may be placed and a wavelength filter may also be placed on the screen, in particular when the optical elements are diffractive lenslets.

Images of the fringes displayed on screen as seen through the lens element 10 are recorded by the camera 22.

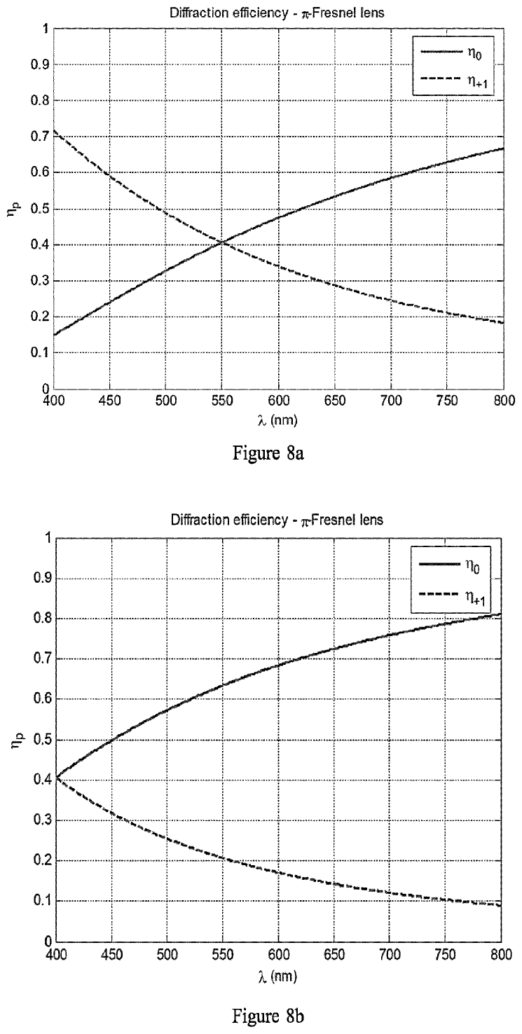

FIG. 5 illustrates an example of an optical power map that may be obtained by the fringe deflectometry method of the disclosure.

The two-dimension representation of the local optical power may be obtained using a pupil diameter greater than or equal to 4 mm and smaller than or equal to 15 mm.

The two-dimension representation of the local optical power corresponds to at least 25%, for example at least 50%, for example at least 80%, of the surface of the lens element.

The method of the disclosure may advantageously be used to characterize at least part of the optical elements or at least part of the lens element comprising optical elements. Therefore, the two-dimension representation of the local optical power may correspond to at least a part of the lens element that comprises at least 25%, for example at least 40%, for example at least 80% of the optical elements.

The method of the disclosure may be used to identify the optical elements from the image representing the power levels. For example, a Hough transform may be applied which allows to identify the optical element, in particular optical elements that are microlenses or lenslets.

Alternatively, one may provide as follows to identify the optical elements, in particular the center of said optical elements:
one may binarize the image in order to detect the objects present in the image, any binarization method can be used,
the detected objects are filtered by sizes, in particular objects that are too small and too big compared to the theoretical size of the optical elements are removed,
a circular regression is applied to the remaining objects to obtain the circle describing the object,
one may calculate the quadratic error between the measured object and its best circle, in order to know if the object is circular or not and to keep only the circular objects.

Remains only the objects representing the optical elements and their best circle calculated previously.

According to an embodiment of the disclosure, once the optical element detected the method may comprise prior to determining the optical power distribution a step of masking either detected optical elements or the complementary zone. Advantageously, the characterization of either the optical elements or the complementary zone is more efficient.

The optical elements may have a wide variety of positions and optical functions. Different examples of lens elements with different types of optical elements are described here. The method of the disclosure may be used to determine different features of at least part of the lens element for example depending on the configuration of the optical elements.

According to the method of the disclosure at least part, for example all, of the two-dimension representation of the at least part of the lens element obtained by a deflectometry method is used to determine the optical power distribution over at least part of the two-dimension representation of the lens element.

The optical power distribution may be obtained based over at least part of the two-dimension representation of the local power, on the number of pixels for each shade of gray. For storage and calculation purposes the two-dimension representation comprises typically 256 different shades of gray.

Each shade of gray may be converted into a value of local power. Therefore, allowing to obtain an optical power distribution over at least part of the two-dimension representation of the lens element.

The lens element, for example the optical elements of the lens element, are characterized by analyzing the determined optical power distribution.

For example, the optical power distribution may comprise at least one peak.

According to the disclosure a peak may be characterized by its maximum value, the position of this maximum, but also its width at its basis, or at half of its height. The peak may be also characterized by its integral value (a number of pixels or an area fraction of the whole area analyzed).

The peak area or peak ratio may be compared to the whole area. For example, “50% of the optical surface analyzed is located into the peak”. Counting can be made between the limits corresponding to the basis of the curve. These limits may also correspond to some chosen tolerances. For example “Lmin=peak maximum position (in diopter)−0.25 diopter, Lmax=peak maximum position (in diopter)+0.25 diopter. This tolerance may also be of +/−0.12 diopter or +/−0.50 diopter. It can be related to the order of magnitude of eye's sensibility.

The lens element, for example the optical elements of the lens element, may be characterized by determining the value of the at least one peak in the optical power distribution.

The lens element, for example the optical elements of the lens element, may be characterized by determining the number of peaks in the optical power distribution.

The surface of the least one peak of the determined optical power distribution may be determined and used to characterize at least part of the lens element and/or at least part of the optical elements. When the optical power distribution comprises more than one peak, the surfaces of the different peaks may be determined and used for characterizing at least part of the lens element and/or at least part of the optical elements.

The width value of the least one peak of the determined optical power distribution may be determined and used to characterize at least part of the lens element and/or at least part of the optical elements. When the optical power distribution comprises more than one peak, the width values of the different peaks may be determined and used for characterizing at least part of the lens element and/or at least part of the optical elements.

The degree of symmetry of the least one peak of the determined optical power distribution may be determined and used to characterize at least part of the lens element and/or at least part of the optical elements. When the optical power distribution comprises more than one peak, the degree of symmetry of the different peaks may be determined and used for characterizing at least part of the lens element and/or at least part of the optical elements.

The method of the disclosure may be used to characterize lens elements having different configurations. The following description illustrates the possible configuration for which the method of the disclosure may be particularly useful.

The lens element may comprise a refraction area 12 configured to provide to the wearer in standard wearing conditions, in particular for foveal vision, a first optical power based on the prescription of the wearer for correcting an abnormal refraction of said eye of the wearer.

The wearing conditions are to be understood as the position of the lens element with relation to the eye of a wearer, for example defined by a pantoscopic angle, a Cornea to lens distance, a Pupil-cornea distance, a center of rotation of the eye (CRE) to pupil distance, a CRE to lens distance and a wrap angle.

The Cornea to lens distance is the distance along the visual axis of the eye in the primary position (usually taken to be the horizontal) between the cornea and the back surface of the lens; for example equal to 12 mm.

The Pupil-cornea distance is the distance along the visual axis of the eye between its pupil and cornea; usually equal to 2 mm.

The CRE to pupil distance is the distance along the visual axis of the eye between its center of rotation (CRE) and cornea; for example equal to 11.5 mm.

The CRE to lens distance is the distance along the visual axis of the eye in the primary position (usually taken to be the horizontal) between the CRE of the eye and the back surface of the lens, for example equal to 25.5 mm.

The pantoscopic angle is the angle in the vertical plane, at the intersection between the back surface of the lens and the visual axis of the eye in the primary position (usually taken to be the horizontal), between the normal to the back surface of the lens and the visual axis of the eye in the primary position; for example, equal to −8°.

The wrap angle is the angle in the horizontal plane, at the intersection between the back surface of the lens and the visual axis of the eye in the primary position (usually taken to be the horizontal), between the normal to the back surface of the lens and the visual axis of the eye in the primary position for example equal to 0°.

An example of standard wearer condition may be defined by a pantoscopic angle of −8°, a Cornea to lens distance of 12 mm, a Pupil-cornea distance of 2 mm, a CRE to pupil distance of 11.5 mm, a CRE to lens distance of 25.5 mm and a wrap angle of 0°.

The term “prescription” is to be understood to mean a set of optical characteristics of optical power, of astigmatism, of prismatic deviation, determined by an ophthalmologist or optometrist in order to correct the vision defects of the eye, for example by means of a lens positioned in front of his eye. For example, the prescription for a myopic eye comprises the values of optical power and of astigmatism with an axis for the distance vision.

The refractive area may have a continuous variation of optical power. For example, the optical area may have a progressive addition design.

At least one, preferably all of the, optical element of the plurality of optical elements 14, has an optical function of not focusing an image on the retina of the eye of the wearer, in particular for peripheral vision and preferably for central and peripheral vision.

For example, each optical element of the plurality of optical elements is transparent over the whole visible spectrum.

For example, at least one, preferably all of the, optical element of the plurality of optical elements 14, has an optical function of focusing an image in front of the retina.

In the sense of the disclosure “focusing” is to be understood as producing a focusing spot with a circular section that can be reduced to a point in the focal plane.

Advantageously, such optical function of the optical element reduces the deformation of the retina of the eye of the wearer in peripheral vision, allowing to slow down the progression of the abnormal refraction of the eye of the wearer wearing the lens element.

According to the disclosure, the optical elements may have specific sizes. In particular, the optical elements may have a contour shape being inscribable in a circle having a diameter greater than or equal to 0.1 mm and smaller than or equal to 7.0 mm, preferably greater than or equal to 1.0 mm and smaller than 3.0 mm, for example smaller than 2.0 mm.

The optical elements may be positioned on a mesh.

The mesh on which the optical elements are positioned may be a structured mesh as illustrated in WO2021/069443.

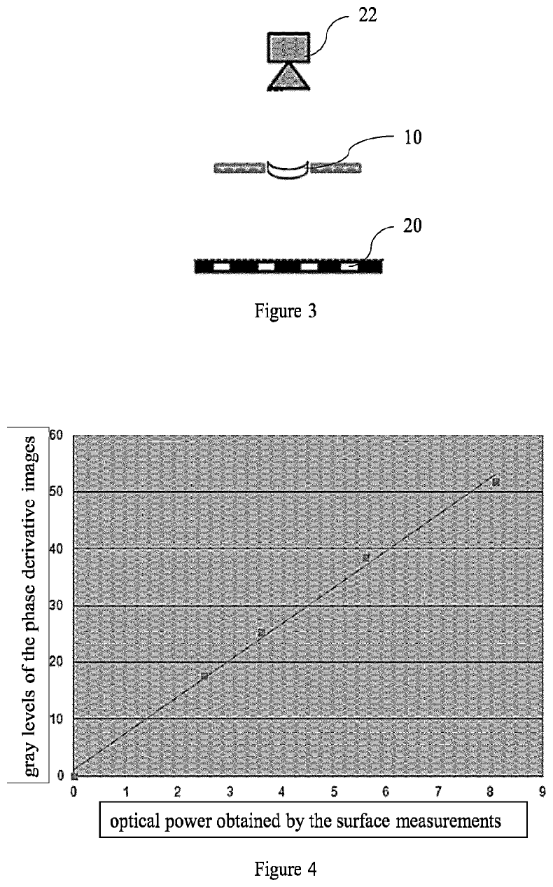

As illustrated on FIG. 2, a lens element 10 according to the disclosure comprises an object side surface F1, for example formed as a convex curved surface toward an object side, and an eye side surface F2 for example formed as a concave surface having a different curvature than the curvature of the object side surface F1.

At least part, for example all, of the optical elements may be located on the front surface of the lens element.

At least part, for example all, of the optical elements may be located on the back surface of the lens element.

At least part, for example all, of the optical elements may be located between the front and back surfaces of the lens element. For example, the lens element may comprise zones of different refractive indexes forming the optical elements.

At least one of the optical elements may have an optical function of focusing an image for peripheral vision on a position other than the retina.

Preferably, at least 50%, for example at least 80%, for example all, of the optical elements may have an optical function of focusing an image for peripheral vision on a position other than the retina.

All of the optical elements may be configured so that the mean focus of the light rays passing through each optical element is at a same distance to the retina of the wearer, at least for peripheral vision.

The optical function, in particular the dioptric function, of each optical element may be optimized so as to provide a focus image, in particular in peripheral vision, at a constant distance of the retina of the eye of the wearer. Such optimization requires adapting the dioptric function of each of the optical element depending on their position on the lens element.

The optical elements may be configured so that at least along one section of the lens the mean sphere of the optical elements increases from a point of said section towards the periphery of said section.

At least part of the optical elements, for example at least 50%, for example all of the optical elements are multifocal lenslets. Advantageously, such multifocal lenslet may have a first optical power corresponding to the prescription and a second optical power different from the first optical power so as to focus light other than on the retina of the wearer.

According to an alternative of the disclosure, at least 50%, for example all of the optical elements are diffractive lenslets, for example contiguous diffractive lenslets.

In the context of the present disclosure, two optical elements are to be considered contiguous if there is a path linking the two optical elements all along which one may measure in standard wearing conditions at least one optical power different from the optical power based on the prescription of the wearer for correcting an abnormal refraction of the eye of the wearer.

According to an embodiment of the disclosure, at least one, for example all of the optical elements, has discontinuities, such as a discontinuous surface, for example Fresnel surfaces and/or having a refractive index profile with discontinuities.

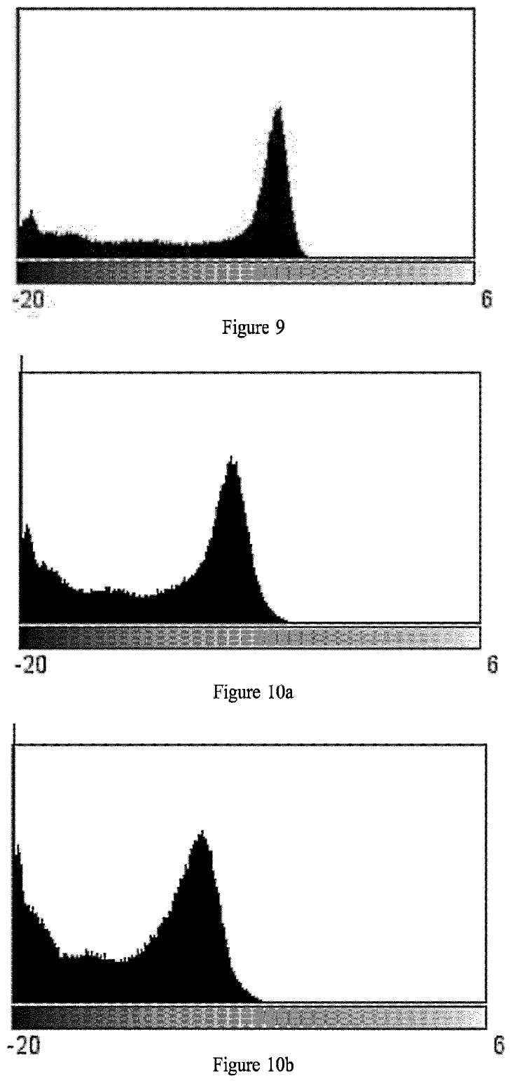

FIG. 6a represents an example of a first diffractive lens radial profile of a contiguous optical element that may be used for the disclosure.

FIG. 6b represents an example of a second diffractive lens radial profile of a contiguous optical element that may be used for the disclosure.

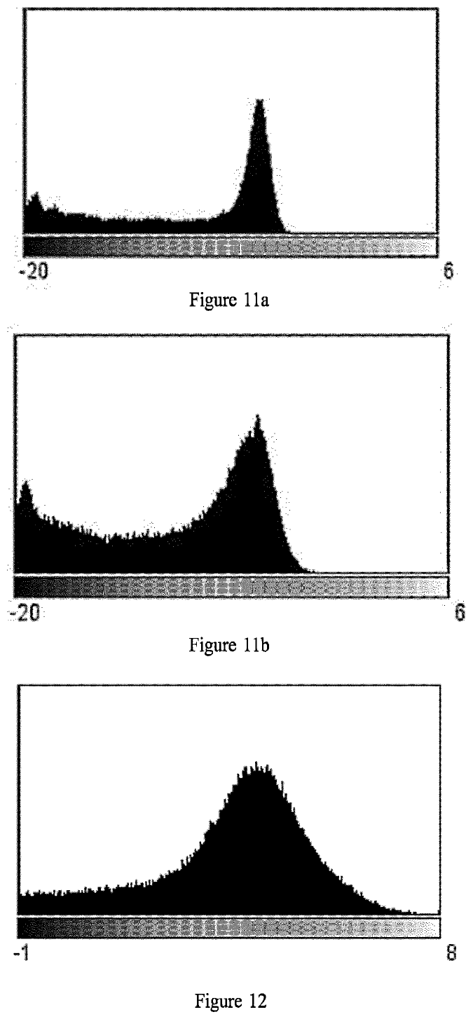

The diffractive lenslet may be a Fresnel lenslet whose phase function ψ(r) has π phase jumps at the nominal wavelength λ₀, as seen in FIG. 7. One may give these structures the name “π-Fresnel lenses” for clarity's sake, as opposition to unifocal Fresnel lenses whose phase jumps are multiple values of 2π. The π-Fresnel lens whose phase function is displayed in FIG. 5 diffracts light mainly in two diffraction orders (order 0 and +1) associated to dioptric powers P(λ₀)=0δ and a positive one, for example P(λ₀)=3δ, with λ₀=550 nm.

An advantage of this design is that the diffraction order dedicated to the prescription of the wearer is not chromatic whereas the one used to provide the second optical function to slow down myopia progression is very chromatic.

A typical size for the optical element is greater than or equal to 2 mm and smaller than or equal to 2.5 mm. Indeed, the inventors have observed that maintaining an optical element size smaller than the wearer eye pupil size is advantageous.

For example, the diffraction efficiency of the 0 and +1 orders is of about 40% at the nominal wavelength λ₀.

To increase the efficiency of the diffraction order corresponding to the wearer prescription one may consider the following:

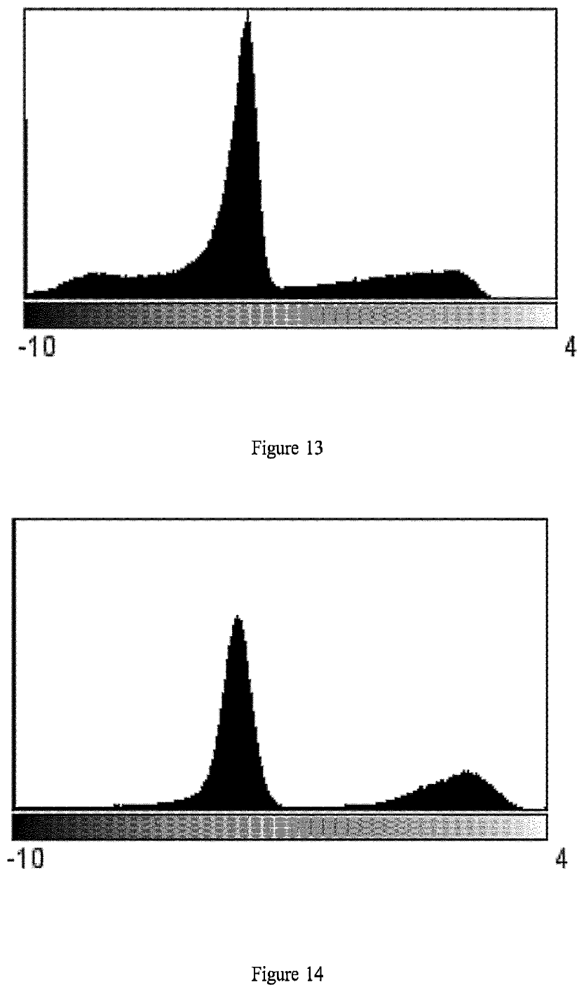

To increase the efficiency of the diffraction order 0 one may decrease the value of λ₀. FIG. 8a shows the diffraction efficiencies with λ₀=550 nm and FIG. 8b shows the diffraction efficiencies if λ₀=400 nm. One can notice that in this case, the diffraction efficiency of order 0 is generally higher, whereas the efficiency of order +1 is lower, on the whole visible spectrum. In this case the dioptric power of the refractive phase function to which we apply the phase jumps should be equal to 1.5*400/550≈1.1δ for λ₀=550 nm instead of 1.5δ in FIG. 8a. This results in a widening of the rings of FIG. 7.

One may in addition or alternatively set to zero one ring out of two of the configurations illustrated on FIG. 7. In this case, the simultaneously bifocal function still exists due to the remaining Fresnel rings, while the rings set to 0 induce a more important proportion of 0δ dioptric power.

One may further consider applying Fresnel structures made of two materials with two different refraction indices and different Abbe numbers to obtain the phase function of FIG. 7 at λ=λ₀ and to get more homogeneous efficiencies on the visible spectrum and/or to privilege one of the two main diffraction orders in relation to the other.

Other combinations with superimposed Fresnel structures could be considered.

The method of the disclosure is particularly useful to characterize at least part of a lens element comprising a plurality of diffractive lenslet, in particular when comprised between the front and back surfaces of the lens element.

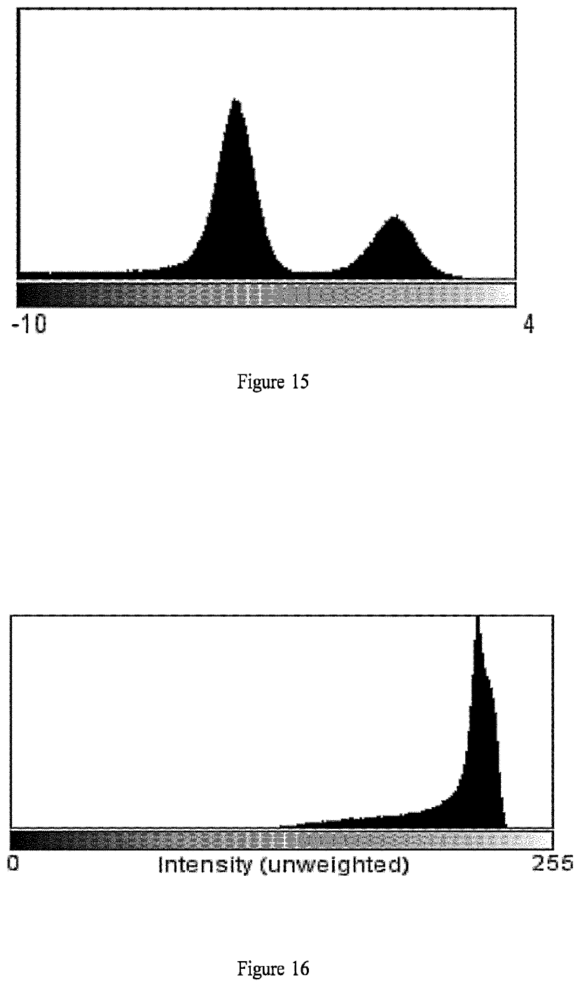

FIG. 9 is an example of optical power distribution obtained by a method of the disclosure used to characterize a lens element comprising a plurality of Pi-Fresnel lenslets.

As illustrated on FIG. 9, the optical power distribution comprises one peak that is the mix of powers and ratio of energy of both orders of diffraction having the biggest efficacy (order 0 and order +1 on PiFresnel).

The optical power distribution can be analysed to help characterize the optical elements. For example, if the ratio at 550 nm is 40/40 between both orders with 0/+4 dp on a plano lens, then the peak position will be around +2 dp. If the ratio becomes 60/20 at 550 nm between both orders 0/+1, then the peak position will move to the left, i.e. in direction of order 0. If ratio becomes 20/60 at 550 nm between both orders, then the peak position will move to the right, i.e. in direction of order +1.

The inventors have observed that if a filter not centered around 550 nm is added it will also have an impact on the result, as power and efficacy of each order of diffraction moves with λ on Pi-Fresnel concept (diffractive concept).

In particular the inventors have found that the peak positioning when having a filter between the screen and the lens at another wavelength than 550 nm changes. For example, considering the theoretical graph illustrated on FIG. 8a of the ratio of a Pi-Fresnel design optimized for 550 nm with 40/40 between both orders with 0/+20 dp on a −10 dp lens (to have −10 dp in order 0 and +10 dp in order +1), then if a filter at 490 nm is added the ratio measured increases the weight of order +1 “+10 dp” and the peak is closer or above 0 dp. On the contrary if a filter at 610 nm is added the weight of order 0 “−10 dp” increases and the peak is further to 0 dp in negative value.

FIG. 10a illustrates the optical power distribution obtained by adding a yellow filter and FIG. 10b illustrates the optical power distribution obtained by adding a red filter.

Thus, the peak value depends on the filter laying on the Pi-Fresnel lens which confirms the measurement significance.

According to an embodiment of the disclosure, the method further comprises:
obtaining at least two two-dimension representations of the local optical power of at least part of the lens element using a deflectometry method at at least two different wavelengths,
determining the optical power distribution over at least part of each of the at least two two-dimension representations of the lens element, and
characterizing the optical elements by comparing the at least two determined optical power distributions.

For example, one of the at least two different wavelengths corresponds to the nominal wavelength of the diffractive lenslets.

The method of the disclosure may also characterize the quality of the lens element, in particular a difference in optical power and/or ratio of the different optical elements.

The width of the peak on the optical power distribution may provide an indication on the probability of a defect of the optical element, in particular of Pi-Fresnel optical elements. For example, if the peak obtained for a lens element has a larger width than the other lens elements, then there is a high probability that there is some defects on this lens, in particular that the lenslets design is not stable on the lens element, with a different power and/or a different ratio.

FIGS. 11a and 11b are examples of a power distribution obtained by the method of the disclosure of a lens elements comprising a distribution of Pi-Fresnel lenslets. The difference between the lens elements of FIGS. 11a and 11b is solely the presence of difference in power distribution in the lenslets of the lens element of FIG. 11b.

On FIG. 11a, the lenslets are similar and there are no or low replication defects.

On FIG. 11b, the lens element has defects on the surface. The defects change the design of the lenslets and they are no more similar, increasing the design dispersion.

Comparing the optical power distributions of FIGS. 11a and 11b shows that even if the position of the peaks are similar, the width of the peak increases a lot with the presence of defects as represented on FIG. 11b.

Even if particularly advantageous for characterizing a lens element comprising Pi-Fresnel lenslets, the method of the disclosure can be used with other types of optical elements.

For example, at least 50%, for example all of the optical elements are refractive lenslets.

FIG. 12 is an example of optical power distribution of a part of a lens element comprising contiguous spherical lenslets.

With this concept of contiguous spherical lenslets, the optical power distribution shows only one peak which is around the global power of the lenslets, so depending on the optical power of the spherical lenslets. One can also observe that the peak is quite “symmetrical” (gaussian).

Positioning of the peak and width of the peak are good indicators of the respect of the design of the lenslets.

The method of the disclosure is particularly interesting to evaluate quickly the respect of the global design, and to quickly compare the lens elements, for example optical lenses, of different batches.

The method of the disclosure may be implemented to characterize a lens element comprising contiguous aspherical lenslets.

The optical power distribution of at least part of a lens element comprising contiguous aspherical lenslets comprises only one peak around the global power of the lenslets, so depending on the curvature of these aspherical lenslets. Such peak is quite much less “symmetrical” than the one of the optical power distribution obtained with contiguous spherical lenslets, more spread on the left of the peak, which is due to the aspherical profile with a reduction of power with the eccentricity of the lenslets.

Therefore, the positioning of the peak, shape and width of the peak are good indicators of the respect of the design of the lenslets.

The method according to the disclosure provides a way of easily differentiating spherical and aspherical lenslets design: symmetrical peak for spherical vs asymmetrical peak for aspherical.

The method of the disclosure may be used to characterize lens elements having aspherical lenslet position on concentric circles as illustrated on FIG. 1 and disclosed in greater details in WO2019/166659.

FIG. 13 is an example of optical power distribution obtained with the method of the disclosure on at least part of a lens element having on the front surface aspherical lenslets positioned on concentric circles covered with dip coating.

On the optical power distribution, one can identify one peak for the Rx, then a very spread peak on the right which corresponds to the power of the aspherical lenslets. One can further also identify another peak on the left in the “negative” part which is mainly due to the coating spreading along the lenslets and especially at the transitions between the lenslets and the Rx area (due to non homogeneous deposit of the coating on the lenslets and especially at the transition which creates a zone of discontinuity in power).

The positioning of the different peaks, shape and width are good indicators of the respect of the design of the lenslets and of the Rx area.

FIG. 14 is an example of optical power distribution obtain with the method of the disclosure on at least part of a lens element having on the front surface aspherical lenslets positioned on concentric circles free of coating.

On the optical power distribution, one can identify one peak for the Rx, then a spread and asymmetrical peak on the right (but less “spread” than after coating like in FIG. 13) which corresponds to the power of the aspherical lenslets on the optical element before coating. One can further observe the lack of any more peak on the left in the “negative” part, proving that this peak appearing after coating was due to the deposit of coating changing the shape of the lenslets and creating local negative curvatures at the transitions with the Rx.

Therefore, positioning of the different peaks, shape and width are good indicators of the respect of the design of the lenslets and of the Rx area. The method of the disclosure is also a good solution to easily compare different lens elements of one batch in production, which could allow to limit the number of lens elements that are to be measured in great detail.

FIG. 15 is an example of optical power distribution obtained with the method of the disclosure on at least part of a lens element having between the front and rear surfaces spherical lenslets positioned on concentric circles.

The spherical lenslets are obtained using a process of encapsulation of these spherical lenslets inside the lens. Therefore, no coating covers the spherical lenslets.

On the optical power distribution, one can identify two peaks: one peak corresponding to the Rx areas, and on the right a second peak corresponding to the spherical curvature of lenslets (symmetrical and well defined, characteristics of a spherical lenslets). The optical power distribution does not comprise a peak on the left of Rx peak, this can be explained by the fact we have no more coating effect creating negative local curvatures thanks to the encapsulation of lenslets inside the lens element.

The optical power distribution on FIG. 15 is well consistent with the definition of the design (spherical lenslets+Rx areas: 2 peaks quite symmetrical like “gaussians”) and with the improvement of the process (encapsulation).

The method of the disclosure may further be used to characterize a lens element where at least 50%, for example, of the optical elements are diffusive lenslets.

FIG. 16 is an example of gray level distribution obtained with the deflectometry method according to the disclosure measured on a lens element comprising diffusive lenslets without coating.

The distribution curve on FIG. 16 shows a peak at the Rx (the grey zone between the diffusive lenslets, for example laser microstructures creating the diffusion), and a spread on the left with more negative values diffusive lenslets themselves. The distribution curve of FIG. 16 is very different from the ones of FIGS. 12 to 15 with spherical or aspherical lenslets because there is no peak created by the diffusive lenslets, but more a “continuous spread” of the powers in the negative part.

The disclosure has been described above with the aid of embodiments without limitation of the general inventive concept. Many further modifications and variations will be apparent to those skilled in the art upon making reference to the foregoing illustrative embodiments, which are given by way of example only and which are not intended to limit the scope of the disclosure, that being determined solely by the appended claims.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Any reference signs in the claims should not be construed as limiting the scope of the disclosure.

1. Method for characterizing at least part of a lens element adapted for a wearer and comprising a plurality of optical elements, each optical element of the plurality of optical elements providing at least an optical power;
wherein the method comprises:
obtaining a two-dimension representation of the local optical power of at least part of the lens element using a deflectometry method,
determining the optical power distribution over at least part of the two-dimension representation of the lens element, and
characterizing at least the part of the lens element within said at least part of the two-dimension representation of the lens element by analyzing the determined optical power distribution.

2. The method according to claim 1, wherein the two-dimension representation of the local optical power corresponds to at least 25%, of the surface of the lens element.

3. The method according to claim 1, wherein the two-dimension representation of the local optical power corresponds to at least a part of the lens element that comprises at least 25%, of the optical elements.

4. The method according to claim 1, wherein
the images used for the deflectometry method consist of pixels smaller than or equal to 0.05 mm×0.05 mm.

5. The method according to claim 1, wherein the part of the lens element within said at least part of the two-dimension representation of the lens element is characterized based on at least one of:
the optical power value of at least one peak of the determined optical power distribution, and/or
the surface of at least one peak of the determined optical power distribution, and/or
the width value of at least one peak of the determined optical power distribution, and/or
the degree of symmetry of at least one peak of the determined optical power distribution.

6. The method according to claim 1, wherein the method characterizes at least part of the optical elements within said at least part of the two-dimension representation of the lens element.

7. The method according to claim 1, wherein at least 50% of the optical elements are multifocal lenslets.

8. The method according to claim 1, wherein at least 50% of the optical elements are diffractive lenslets.

9. The method according to claim 8, wherein the method comprises:
obtaining at least two two-dimension representations of the local optical power of at least part of the lens element using a deflectometry method at at least two different wavelengths,
determining the optical power distribution over at least part of each of the at least two two-dimension representations of the lens element, and
characterizing the optical elements by comparing the at least two determined optical power distributions.

10. The method according to claim 9, wherein one of the at least two different wavelengths corresponds to the nominal wavelength of the diffractive lenslets.

11. The method according to claim 1, wherein at least 50% of the optical elements are refractive lenslets.

12. The method according to claim 1, wherein at least 50% of the optical elements are diffusive lenslets.

13. The method according to claim 1, wherein the lens element comprises a refraction area having a refractive power based on the prescription for correcting an abnormal refraction of an eye of the wearer.

14. Method for checking the conformity of a manufactured lens element adapted for a wearer and comprising a plurality of optical elements, each optical element of the plurality of optical elements providing at least an optical power so as to at least one of slow down, retard or prevent a progress of the abnormal refraction of the eye of the wearer,
wherein the method comprises:
obtaining characterizing data relating to at least one optical characteristic of the optical elements of the lens element to be manufactured,
characterizing the optical elements of the manufactured lens element using the method of claim 1,
comparing the characteristics of the optical elements of the manufactured lens element with the characterizing data so as to check the conformity of the manufactured lens element.

15. Method for controlling a lens element manufacturing process for manufacturing lens elements, each lens element being adapted for a wearer and comprising a plurality of optical elements, each optical element of the plurality of optical elements providing at least an optical power so as to at least one of slow down, retard or prevent a progress of the abnormal refraction of the eye of the wearer, wherein the method comprises the steps of:
a) manufacturing a lens element according to a manufacturing process,
b) determining at least one characteristic of the manufactured lens element of step a) according to the method of claim 1,
c) recording the difference between the determined at least one characteristic and a reference value,
d) repeating regularly step a) to c) and checking the evolution of the difference over time,
wherein the evolution of at least one parameter of the manufacturing process used for manufacturing the lens elements is checked over time and the evolution over time of said difference is related with the evolution over time of the at least one parameter of the manufacturing process.
